(19) United States
(12) Patent Application Publication
(10) Pub. No.: US 2026/0121282 A1
(43) Pub. Date: Apr. 30, 2026

(54) WEARABLE ELECTRONIC DEVICE

(71) Applicant: MEDIATEK INC., Hsinchu City (TW)

(72) Inventors: Ho-Chung CHEN, Hsinchu City (TW); Chung-Yu HUNG, Hsinchu City (TW)

(21) Appl. No.: 19/365,376

(22) Filed: Oct. 22, 2025

Related U.S. Application Data
(60) Provisional application No. 63/711,734, filed on Oct. 25, 2024.

(51) Int. Cl. H01Q 1/27; G04G 17/04; H01Q 7/00; H01Q 9/04; H01Q 9/16; H01Q 15/02

(52) U.S. Cl. CPC H01Q 1/273; G04G 17/04; H01Q 7/00; H01Q 9/0407; H01Q 9/16; H01Q 15/02

(57) ABSTRACT

A wearable electronic device is provided. The wearable electronic device includes a first structure and a second structure. The first structure includes a first antenna module. The first antenna module is embedded in the first structure. The second structure is movably mounted on the first structure. The second structure includes a second antenna module disposed in or on the second structure.

### CROSS REFERENCE TO RELATED APPLICATIONS

This application claims the benefit of U.S. provisional application No. 63/711,734, filed on Oct. 25, 2024, the entirety of which is incorporated by reference herein.

### TECHNICAL FIELD

The present disclosure relates to a wearable electronic device, and, in particular, it relates to a wearable electronic device for both terrestrial network communication and non-terrestrial network (NTN) satellite communication.

### BACKGROUND

Over the past few decades, there has been significant growth in the use of wireless mobile devices. Alongside advancements in algorithms, breakthroughs in antenna design have expanded wireless communication from handheld devices to wearable technology, where the antenna area is crucial for efficiency. With the advent of the satellite communication era, more stringent budget requirements necessitate higher efficiency, circular polarization, or the use of directional antennas, posing challenges for wearable electronic devices. Therefore, further improvements in wearable electronic devices are required.

### BRIEF SUMMARY

An embodiment of the present disclosure provides a wearable electronic device. The wearable electronic device includes a first structure and a second structure. The first structure includes a first antenna module embedded in the first structure. The second structure is movably mounted on the first structure. The second structure includes a second antenna module disposed in or on the second structure

### BRIEF DESCRIPTION OF THE DRAWINGS

The present disclosure can be more fully understood by reading the subsequent detailed description and examples with references made to the accompanying drawings, wherein:

FIG. 1A is a schematic perspective view of a wearable electronic device in a closed configuration in accordance with some embodiments of the disclosure;

FIG. 1B is a schematic perspective view of a wearable electronic device in an open configuration in accordance with some embodiments of the disclosure;

FIG. 2 is a schematic perspective view of a wearable electronic device in a closed configuration in accordance with some embodiments of the disclosure;

FIG. 3 is a schematic perspective view of a wearable electronic device in a closed configuration in accordance with some embodiments of the disclosure;

FIGS. 4A, 4B, 4C and 4D are schematic perspective views of a second structure of a wearable electronic device in a closed configuration in accordance with some embodiments of the disclosure, showing the type of a second antenna of second structure;

FIG. 5A is a schematic perspective view of a wearable electronic device in accordance with some embodiments of the disclosure, showing the arrangements of a lens, a first structure and the second structure;

FIG. 5B is a cross-sectional view of the wearable electronic device in accordance with some embodiments of the disclosure shown in FIG. 5A;

FIGS. 6A and 6B are schematic perspective views of a wearable electronic device in an open configuration in accordance with some embodiments of the disclosure, showing the relative positions between the first structure and the second structure;

FIGS. 7A and 7B are schematic perspective views of a wearable electronic device in an open configuration in accordance with some embodiments of the disclosure, showing the relative positions between the first structure and the second structure;

FIGS. 8A and 8B are schematic perspective views of a wearable electronic device in an open configuration in accordance with some embodiments of the disclosure, showing the relative positions between the first structure and the second structure; and

FIG. 9 is a schematic perspective view of a wearable electronic device in a closed configuration in accordance with some embodiments of the disclosure.

### DETAILED DESCRIPTION

The following description is made for the purpose of illustrating the general principles of the disclosure and should not be taken in a limiting sense. The scope of the disclosure is best determined by reference to the appended claims.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

The integration of screens, batteries, memories, powers, baseband, and radio frequency integrated circuits (RF ICs), along with multiple antennas in wireless devices, represents a significant technological advancement. Compared to handheld smartphones, wearable devices have considerably smaller printed circuit board (PCB) areas. Consequently, the peak gain of an L-band (1-2 GHz) wearable watch antenna is 3 to 5 dB lower than that of a smartphone antenna. This reduced antenna gain cannot be compensated for by simply increasing the transmitted power due to the limited battery capacity of wearable devices. Furthermore, the stringent link budget requirements of non-terrestrial network (NTN) satellite communications introduce new challenges.

In another aspect, the evolution of antenna architectures over the past century—from dipole, patch, loop, lens antennas, etc. to antenna array thereof—demonstrates that different antenna characteristics are suitable for various applications. Physically, large antenna surface areas and appropriate signal-to-ground spacing remain critical determinants of antenna performance. Therefore, there is a need to further improve the antenna of the wearable electronic device for both terrestrial network communication and non-terrestrial network (NTN) satellite communication.

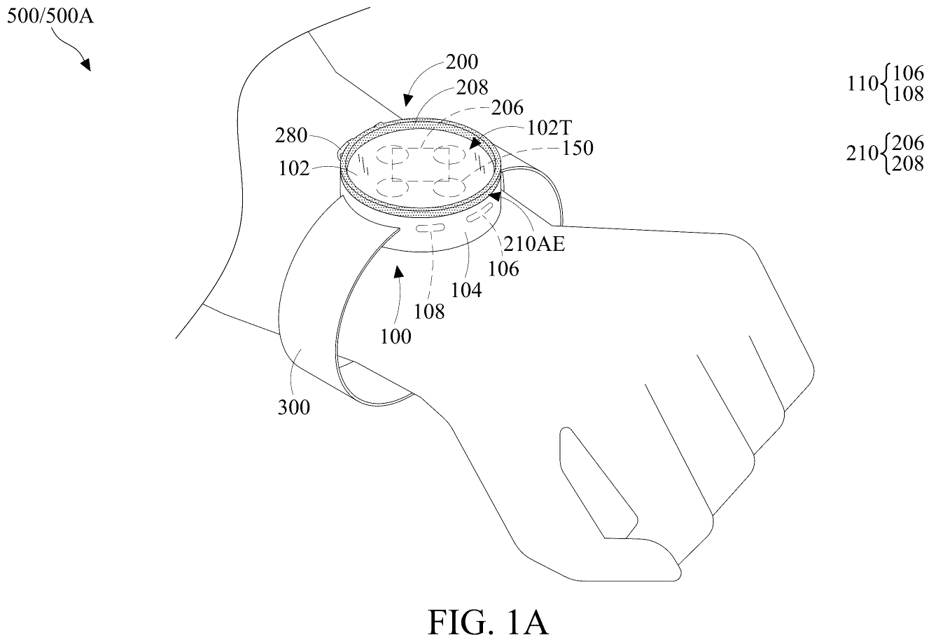

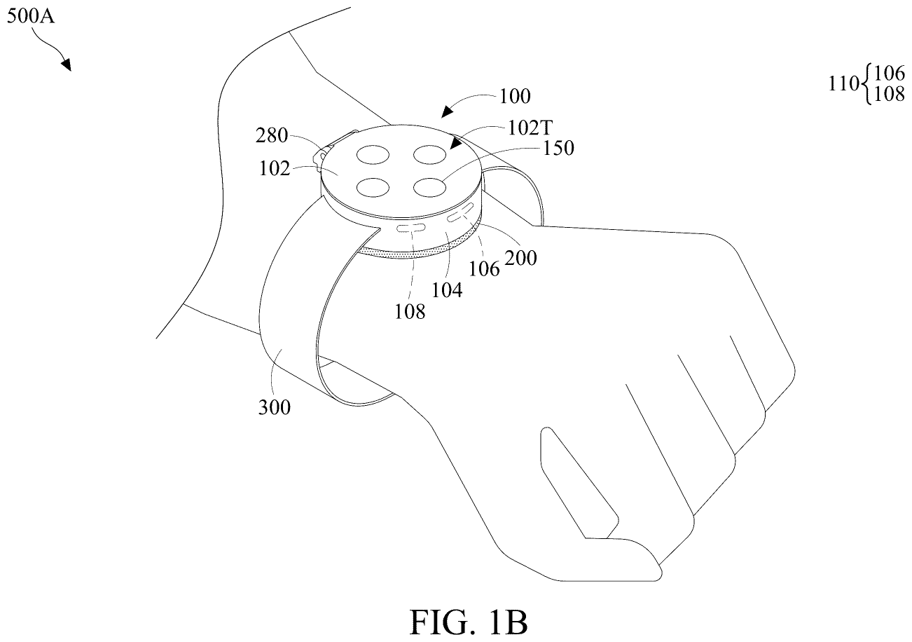

FIG. 1A is a schematic perspective view of a wearable electronic device 500 (including wearable electronic device 500A, 500B, 500C, 500D, 500E, 500F, 500G, 500H, 500J-1, 500J-2, 500K-1, 500K-2, 500L-1, 500L-2 and 500M) in a closed configuration in accordance with some embodiments of the disclosure. FIG. 1B is a schematic perspective view of a wearable electronic device 500A of FIG. 1A in an open configuration in accordance with some embodiments of the disclosure. In some embodiments, the wearable electronic device 500 may include a smartwatch having functions of both terrestrial network communication and non-terrestrial network (NTN) satellite communication.

As shown in FIGS. 1A and 1B, the wearable electronic device 500 (or the wearable electronic device 500A) may at least include a first structure 100 and a second structure 200.

In some embodiments, the first structure 100 may be an electronic component having functions similar to some functions of a smart phone, such as communication, messaging, internet, sensor, or photographing. In addition, the first structure 100 may be integrated and communicated with other mobile devices (such as a smart phone) using software applications installed in the first structure 100 and the mobile devices (not shown).

The first structure 100 may also have a function of a primary display of the wearable electronic device 500 (or the wearable electronic device 500A). In some embodiments, the first structure 100 may be or may include the watch dial of the smartwatch (the wearable electronic device 500), the watch dial may provide functions such as display, voice, and human-computer interaction. In some embodiments, the first structure 100 (or the watch dial of the smartwatch) includes a display module 102 and a housing 104, the display module 102 may disposed on the housing 104. The display module 102 and the housing 104 may be part of the watch dial. The smartwatch (or wearable electronic device 500) may also include additional components such as a strap or wristband. The display module 102, for example, a touch screen module, may receive inputs, such as touch inputs, from the user. In addition, the top surface 102T of the display module 102 may serve as a watch face (or a primary watch face) of the wearable electronic device 500 (or the wearable electronic device 500A). Icons 150 of the software applications installed in the first structure 100 may be displayed on the watch face 102T.

The housing 104 may define a space for accommodating the display module 102. As shown in FIGS. 1A and 1B, the display module 102 is disposed in the housing 104. An outer surface of the housing 104 may be substantially defined as at least a portion of an outer surface of first structure 100.

In some embodiments, the first structure 100 may further include a first antenna module 110 embedded in the first structure 100 (e.g., in/on the housing 104). The first antenna module 110 of the first structure 100 may be used for terrestrial network communication and/or non-terrestrial network (NTN) satellite communication of the wearable electronic device 500 (or the wearable electronic device 500A). In some embodiments, the first antenna module 110 may include a first antenna 106 and a first grounding (GND) component 108. In some embodiments, the first antenna 106 may include a dipole antenna, a loop antenna, a single patch antenna, a circular polarization antenna or other applicable antennas or an antenna array thereof.

In some embodiments, the first structure 100 has a top-view shape including circular shape, rectangular shape, oval shape, or another suitable shape.

The second structure 200 is located on the first structure 100. In some embodiments, the second structure 200 maybe movably mounted on the first structure 100 or the watch dial of the wearable electronic device 500. In some embodiments, the second structure 200 may function as a cover or a secondary display of the wearable electronic device 500. In some embodiments, the second structure (cover) 200 may be made of a transparent material or an opaque material. In some embodiments, the second structure 200 used as a cover may be made of a transparent material includes glass, plastic, or another applicable transparent material. In some embodiments, the second structure 200 having a function of a secondary display may include a printed circuit board (PCB) and a secondary touch screen, which are made of opaque materials, for example, organic and/or inorganic dielectric materials and metals.

In some embodiments, the second structure 200 may further include a transparent conductive film (e.g., indium tin oxide (ITO)) embedded in it. The transparent conductive film may be used as conductive routings or antennas.

The second structure 200A may include a second antenna module 210 mounted in or on the second structure 200. In some embodiments, the second antenna module 210 may be used for non-terrestrial network (NTN) satellite communication and/or terrestrial network communication of the wearable electronic device 500 (or the wearable electronic device 500A). In some embodiments, the second antenna module 210 may include a second antenna 206 and a second grounding (GND) component 208. In some embodiments, the second antenna 206 may include a dipole antenna, a loop antenna, a single patch antenna, a circular polarization antenna or other applicable antennas or an antenna array thereof. In some embodiments, the first antenna 106 and the second antenna 206 may have the same or different antenna types. In some embodiments, the second grounding (GND) component 208 may be arranged along an edge 210AE of the second structure 210. It should be noted that the arrangement of second antenna 206 and the second grounding (GND) component 208 is only an example and is not a limitation to the present disclosure. In some embodiments, the second antenna module 210 may be made of a transparent material (including glass, plastic, or another applicable transparent material) or an opaque material (including organic and/or inorganic dielectric materials and metals). In some embodiments, the first antenna module 110 is disposed in/on the watch dial of the wearable electronic device 500 (or the first structure 100) and the second antenna module 210 is disposed in/on the cover or in/on the second display module. In some embodiments, the second antenna module 210 is additionally added. Since the original first antenna module 110 in the wearable electronic device 500 is relatively small due to space limitations, the inclusion of the second antenna module 210 significantly enhances the communication capabilities of the device, including both terrestrial network communication and non-terrestrial network (NTN) satellite communication.

As shown in FIGS. 1A and 1B, the second structure 200 may be movably mounted on the first structure 100 by the hinge 280 connected between the first structure 100 and the second structure 200. In some embodiments, the second structure 200 may be flipped, folded, slidable or rotated with respect to the first structure 100. For example, as shown in FIG. 1A, when the wearable electronic device 500 (or the wearable electronic device 500A) is in the closed configuration, the second structure 200 may completely or partially cover the first structure 100.

In some embodiments, when the wearable electronic device 500 (or the wearable electronic device 500A) is in the open configuration, the second structure 200 may be flipped, unfolded, slid, or rotated with respect to the first structure 100. For example, as shown in FIG. 1B, when the wearable electronic device 500A is in the open configuration, the second structure 200 may be slidable or rotated with respect to the first structure 100 and covered by the first structure 100 in the open configuration. The second structure 200 may be positioned below the first structure 100, or it may be located in other positions, such as beside the first structure 100, when the first structure 100 and the second structure 200 are in the open configuration. When the first structure 100 and the second structure 200 are in the open configuration, the second antenna module 210 in the second structure 200 may exhibit higher gain. Conversely, when the two structures are in the closed configuration, the second antenna module 210 may exhibit lower gain.

It is noted that the first antenna module 110 for terrestrial network communication and/or non-terrestrial network (NTN) satellite communication of the wearable electronic device 500 is worked when the first structure 100 and the second structure 200 are in both the open and closed configurations.

In some embodiments, the second structure 200 may have a top-view shape including circular shape, rectangular shape, oval shape, or another suitable shape corresponding to the top-view shape of the first structure 100. For example, the second structure 200 has a circular top-view shape corresponding the circular first structure 100. When the wearable electronic device 500 (or the wearable electronic device 500A) is in the closed configuration, the first structure 100 may be completely or partially covered by the second structure 200.

In some embodiments, the wearable electronic device 500 (or the wearable electronic device 500A) may further include at least one wristband 300 connected to the first structure 100. The wristband 300 may be adjustable in order to fasten the wearable electronic device 500 to a user's wrist.

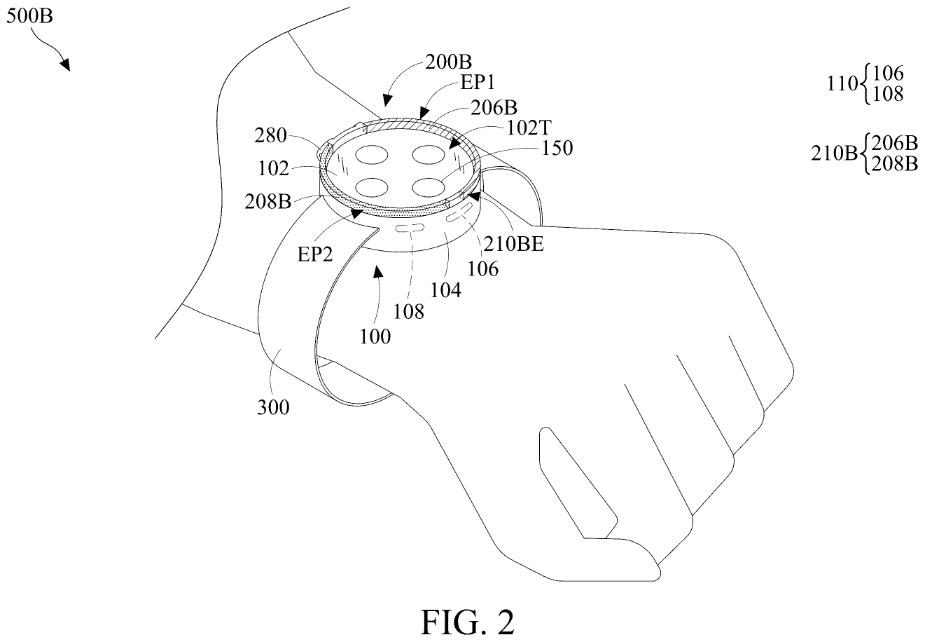

FIG. 2 is a schematic perspective view of a wearable electronic device 500B in a closed configuration in accordance with some embodiments of the disclosure, showing the arrangement of a second antenna module 210B of a second structure 200B. Elements of the embodiments that are the same or similar to those previously described with reference to FIGS. 1A and 1B are not repeated herein, in the interests of brevity.

As shown in FIG. 2, the second structure 200B of the wearable electronic device 500B may be a transparent cover. The second structure 200B may include the second antenna module 210B. In addition, the second antenna module 210B may include a second antenna 206B and a second grounding (GND) component 208B. In this embodiment, the second antenna 206B may include a dipole antenna or other applicable antennas. In some embodiments, the second antenna 206B and the second grounding (GND) component 208B are arranged opposite each other. In addition, the second antenna 206B and the second grounding (GND) component 208B are arranged along a first portion EP1 and a second portion EP2 of an edge 210BE of the second structure 210B. In some embodiments, the first portion EP1 and a second portion EP2 may be separated from each other by the hinge 280. Using this arrangement of the second antenna 206B and the second grounding (GND) component 208B, when the wearable electronic device 500B is in the closed configuration, the icons 150 of the software applications displayed on the watch face 102T of the first structure 100 are not blocked by the second antenna 206B and the second grounding (GND) component 208B and still can be visible to the user.

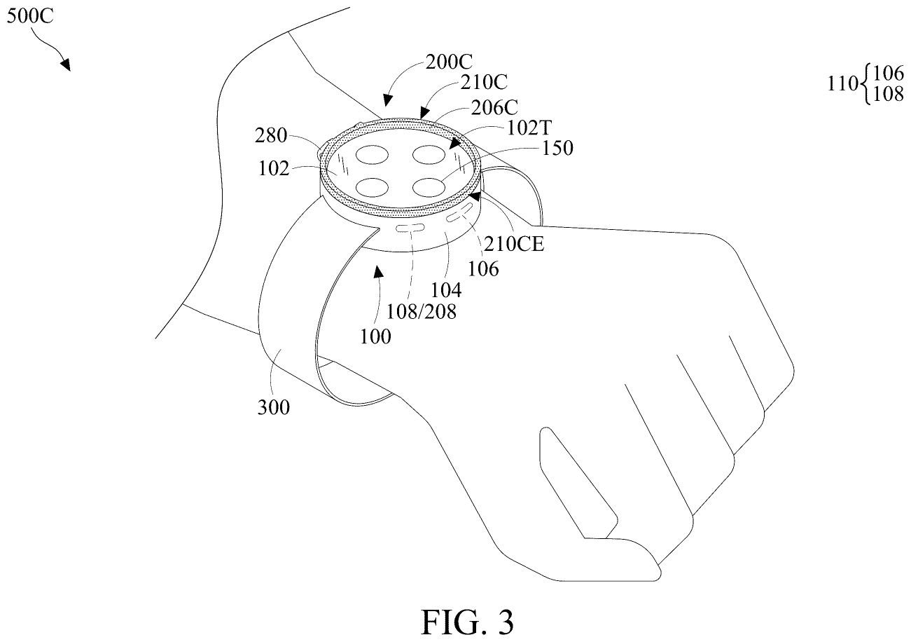

FIG. 3 is a schematic perspective view of a wearable electronic device 500C in a closed configuration in accordance with some embodiments of the disclosure, showing the arrangement of a second antenna module 210C of a second structure 200C. Elements of the embodiments that are the same or similar to those previously described with reference to FIGS. 1A, 1B and 2 are not repeated herein, in the interests of brevity.

As shown in FIG. 3, the second structure 200C of the wearable electronic device 500C may be a transparent cover. The second structure 200C may include the second antenna module 210C and a second grounding (GND) component 208. In addition, the second antenna module 210C may include a second antenna 206C. In this embodiment, the second antenna 206C may include a loop antenna. In some embodiments, the second antenna 206C is arranged along an edge 210CE of the second structure 210C. In some embodiments, the hinge 280 may be connected between the opposite ends of the second antenna 206C. In addition, the second grounding (GND) component 208 may be disposed in the first structure 100 and coupled to the second antenna 206C. For example, the first grounding (GND) component 108 and the second grounding (GND) component 208 may be arranged in the same position in the first structure 100. Using this arrangement of the second antenna 206C, when the wearable electronic device 500C is in the closed configuration, the icons 150 of the software applications displayed on the watch face 102T of the first structure 100 are not blocked by the second antenna 206C and still can be visible to the user.

The wearable electronic devices 500A, 500B, and 500C have the following advantages. In some embodiments, since the second structures 200A, 200B and 200C are provided as covers of the wearable electronic devices 500A, 500B, and 500C, the second structures 200A, 200B and 200C may provide larger surface areas for the arrangements of the corresponding second antennas 206A, 206B and 206C for non-terrestrial network (NTN) satellite communication and/or terrestrial network communication. Therefore, the second antennas 206A, 206B and 206C may have an increased surface area and various designs of antenna types to improve communication efficiency (e.g., dual polarization or high gain).

In some embodiments, the function of non-terrestrial network (NTN) satellite communication and/or terrestrial network communication of the wearable electronic devices 500A, 500B, and 500C may be activated only in the open configuration. Therefore, the standby time of the wearable electronic devices 500A, 500B, and 500C may be further increased.

Furthermore, in the wearable electronic device 500C, the distance between the second antenna 206C and the second grounding (GND) component 208 in a closed configuration is less than the distance between the second antenna 206C and the grounding (GND) component 208 in an open configuration. Therefore, the second antenna 206C may have an increased signal-to-ground spacing in the open configuration in which the function of non-terrestrial network (NTN) communication and/or terrestrial network communication of the wearable electronic device 500C is activated, and the performance of the second antenna 206C of the wearable electronic device 500C can be improved.

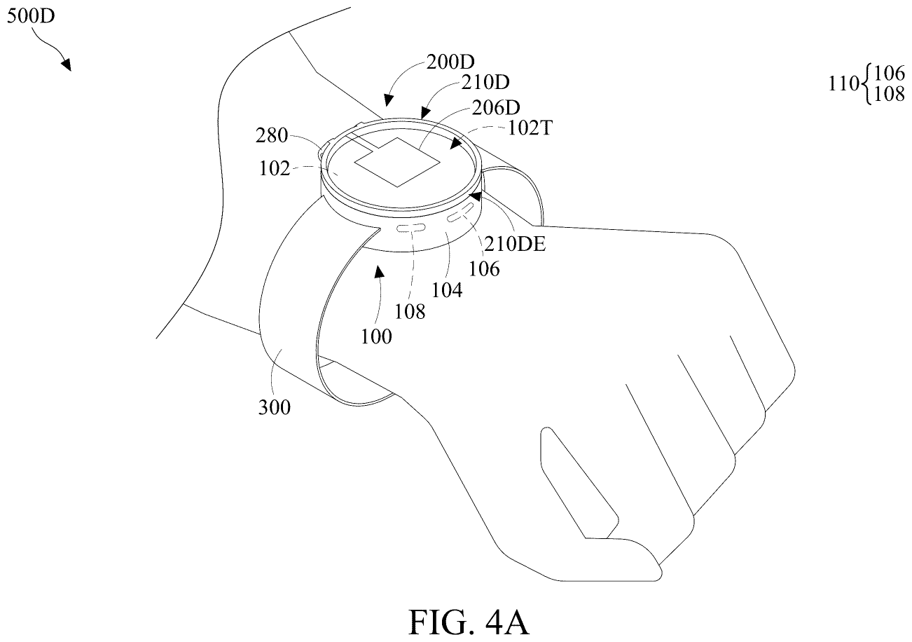

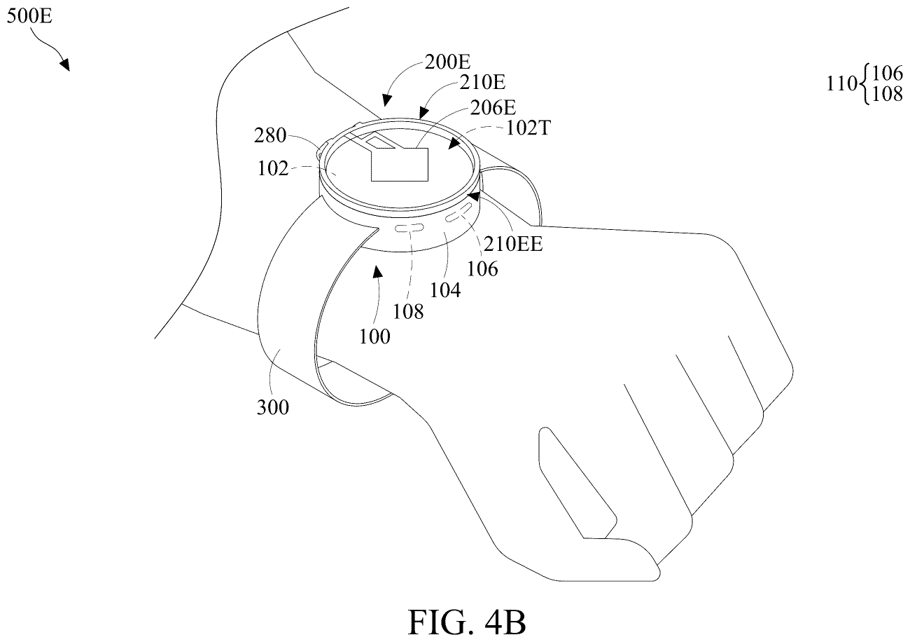

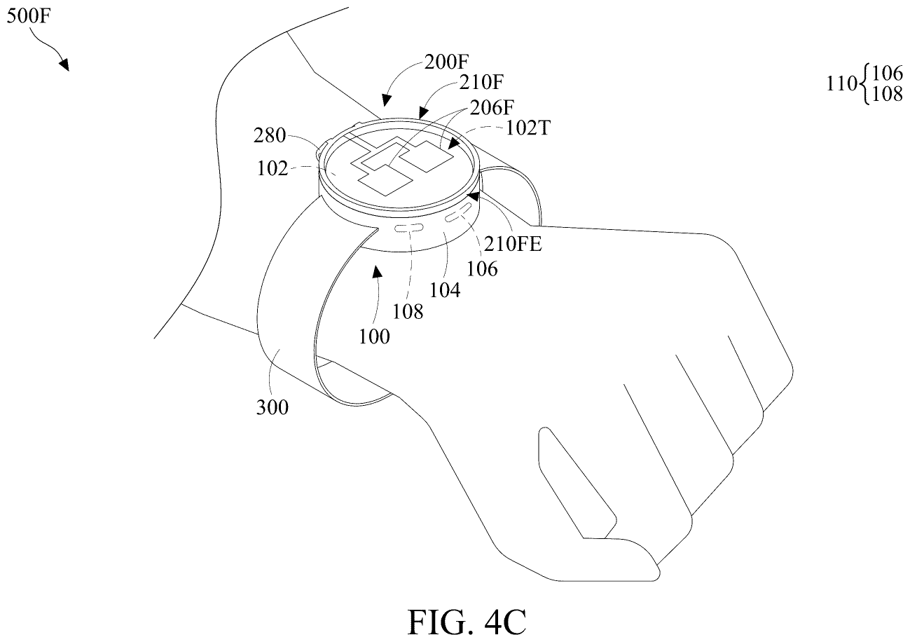

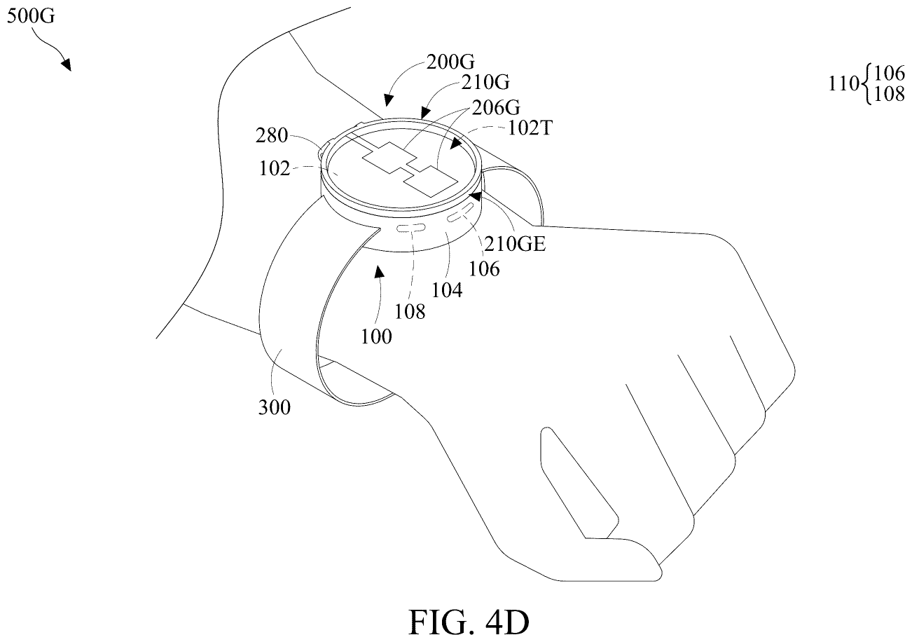

FIGS. 4A, 4B, 4C and 4D are schematic perspective views of the wearable electronic devices 500D, 500E, 500F and 500G in a closed configuration in accordance with some embodiments of the disclosure, showing the types of second antennas 206D, 206E, 206F and 206G of the second antenna modules 210D, 210E, 210F and 210G of the second structures 200D, 200E, 200F and 200G. Elements of the embodiments that are the same or similar to those previously described with reference to FIGS. 1A, 1B, 2 and 3 are not repeated herein, in the interests of brevity. the second antennas 206D, 206E, 206F and 206G are drawn using solid lines for clarity of illustration. Moreover, the icons of the software applications displayed on the watch face 102T of the first structure 100 are omitted in FIGS. 4A, 4B, 4C and 4D.

As shown in FIGS. 4A, 4B, 4C and 4D, in some embodiments, each of the second structure 200D of the wearable electronic device 500D, the second structure 200E of the wearable electronic device 500E, the second structure 200F of the wearable electronic device 500F and the second structure 200G of the wearable electronic device 500G may be a cover (e.g., a transparent cover).

In some embodiments as shown in FIGS. 4A, 4B, 4C and 4D, the second antenna 206D (such as a single patch antenna), the second antenna 206E (such as a circular polarization antenna), and the second antennas 206F and 206G (such as antenna arrays composed of patch antennas or circular polarization antenna) are disposed in or on the second structures 200D, 200E, 200F and 200G.

In addition, the second antennas 206D, 206E, 206F and 206G may be coupled to corresponding grounding (GND) components (not shown) of the second antenna modules 210D, 210E, 210F and 210G. In some embodiments, the grounding (GND) components (not shown) of the second antenna modules 210D, 210E, 210F and 210G may be arranged along edges 210DE, 210EE, 210FE and 210GE of the second structures 200D, 200E, 200F and 200G. Alternatively, the grounding (GND) components (not shown) of the second antenna modules 210D, 210E, 210F and 210G may be arranged in the first structure 100 by conductive routings (not shown) extending from the second structures 200D, 200E, 200F and 200G to the first structure 100. For example, the second grounding (GND) component (not shown) may be arranged in the same position as the first grounding (GND) component 108 in the first structure 100.

In some embodiments, since the second structures 200D, 200E, 200F and 200G are provided as covers of the wearable electronic devices 500D, 500E, 500F and 500G, the entire surface areas of the second structures 200D, 200E, 200F and 200G can be provided for the arrangements of the corresponding second antennas 206D, 206E, 206F and 206G for non-terrestrial network (NTN) satellite communication and/or terrestrial network communication. Therefore, the second antennas 206D, 206E, 206F and 206G may have an increased surface area and various designs of antenna types to improve communication efficiency (e.g., dual polarization or high gain).

In some embodiments, the function of non-terrestrial network (NTN) satellite communication and/or terrestrial network communication of the wearable electronic devices 500D, 500E, 500F and 500G may be activated only in the open configuration. Therefore, the standby time of the wearable electronic devices 500D, 500E, 500F and 500G may be further increased.

In some embodiments, when the grounding (GND) components (not shown) of the second antenna modules 210D, 210E, 210F and 210G are arranged in the first structure 100 of the wearable electronic devices 500D, 500E, 500F and 500G, the distances between the second antennas 206D, 206E, 206F and 206G and the corresponding second grounding (GND) components in a closed configuration are less than the distances between the second antennas 206D, 206E, 206F and 206G and the corresponding second grounding (GND) components in an open configuration. Therefore, the second antennas 206D, 206E, 206F and 206G may have increased an signal-to-ground spacing in the open configuration in which the function of communication of the wearable electronic devices 500D, 500E, 500F and 500G is activated, and the performance of the second antennas 206D, 206E, 206F and 206G of the wearable electronic devices 500D, 500E, 500F and 500G can be improved.

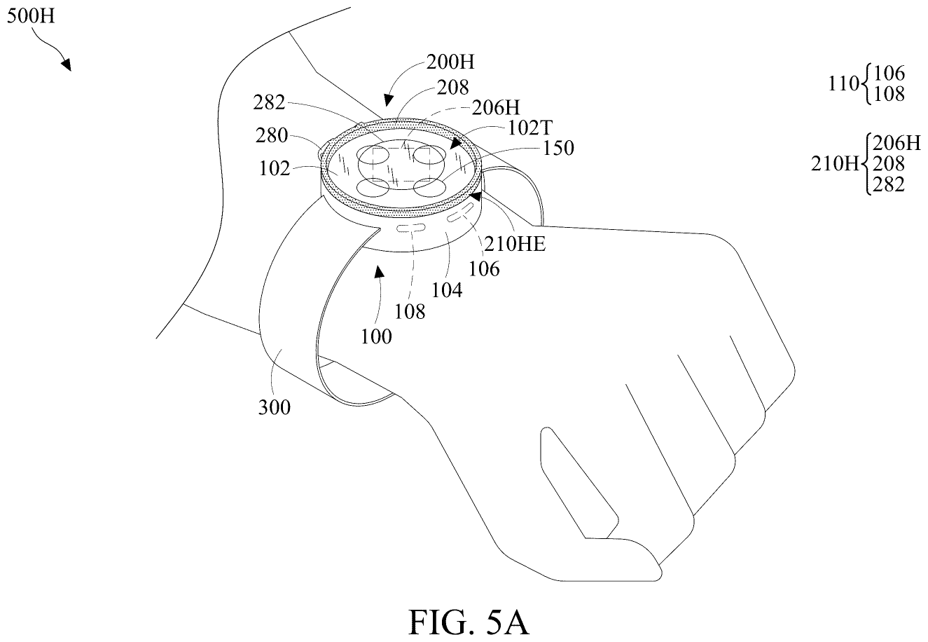

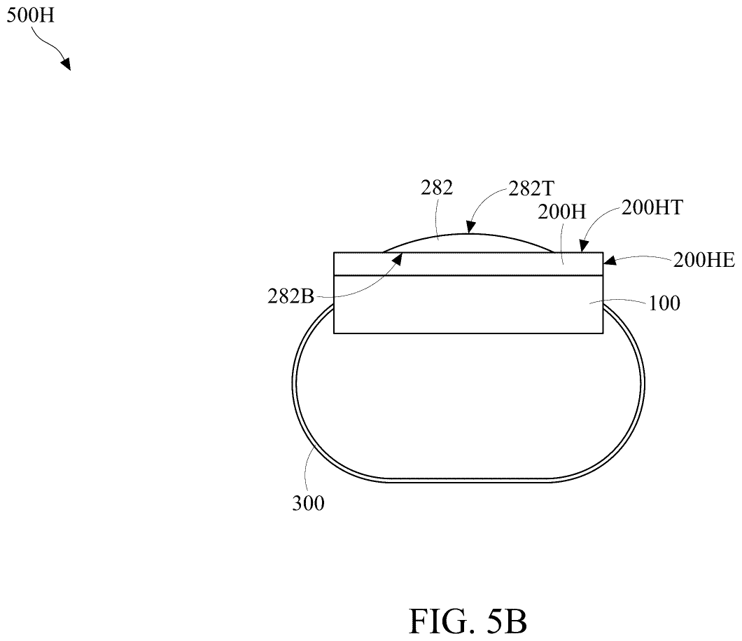

FIG. 5A is a schematic perspective view of a wearable electronic device 500H in accordance with some embodiments of the disclosure, showing the arrangements of a lens 282, the first structure 100 and a second structure 200H. FIG. 5B is a cross-sectional view of the wearable electronic device 500H in accordance with some embodiments of the disclosure shown in FIG. 5A. Elements of the embodiments that are the same or similar to those previously described with reference to FIGS. 1A, 1B, 2, 3 and 4A-4D are not repeated herein, in the interests of brevity.

As shown in FIGS. 5A and 5B, in some embodiments, the second structure 200H of the wearable electronic device 500H may be a cover (e.g., a transparent cover). A second antenna 206H of a second antenna module 210H of the second structure 200H is mounted in the second structure 200H. In some embodiments, the second antenna 206H may include a dipole antenna, a loop antenna, a single patch antenna, a circular polarization antenna or other applicable antennas or an antenna array thereof. For example, the type of the second antenna 206H may be the same or similar to the type of any of the second antennas 206D, 206E, 206F and 206G. In some embodiments, the number, arrangement and type of the second antenna 206H are not limited to the disclosure embodiments.

In addition, the second antenna 206H may be coupled to corresponding grounding (GND) component (not shown) of the second antenna module 210H. In some embodiments, the grounding (GND) component (not shown) of the second antenna module 210H may be arranged along an edge 210HE of the second structure 200H. Alternatively, the grounding (GND) component (not shown) of the second antenna module 210H may be arranged in the first structure 100 by conductive routings (not shown) extending from the second structure 200H to the first structure 100. For example, the second grounding (GND) component (not shown) may be arranged in the same position as the first grounding (GND) component 108 in the first structure 100.

In some embodiments, the wearable electronic device 500H may further include the lens 282 mounted on the second structure 200H and covering the second antenna 206H of the second antenna module 210H. As shown in FIG. 5B, in this embodiment, the lens 282 may be a convex lens, such as a plano-convex lens. The plano-convex lens 282 may have a bottom surface 282B that is flat and a top surface 282T that is outwardly curved. The bottom surface 282B may be disposed on and in contact with the top surface 200HT of the second structure 200H. In addition, the focal point of the lens 282 may be position directly on the second antenna 206H of the second antenna module 210H. In some embodiments, the lens 282 may be mounted in the second structure 200H, ensuring that the upper surface of the second structure 200H remains flat and free of protrusions.

In some embodiments, since the second structure 200H are provided as a cover of the wearable electronic device 500H, the entire surface area of the second structure 200H can be provided for the arrangement of the corresponding second antenna 206H for non-terrestrial network (NTN) satellite communication and/or terrestrial network communication. Therefore, the second antenna 206H may have an increased surface area and various designs of antenna types to improve communication efficiency (e.g., dual polarization or high gain).

In addition, the lens 282 may help to concentrate and focus electromagnetic (EM) waves, thereby increasing directivity and gain of the second antenna 206H of the second antenna module 210H.

Furthermore, the function of non-terrestrial network (NTN) satellite communication and/or terrestrial network communication of the wearable electronic device 500H may be activated only in the open configuration. Therefore, the standby time of the wearable electronic device 500H may be further increased.

In some embodiments, when the grounding (GND) component (not shown) of the second antenna module 210H is arranged in the first structure 100 of the wearable electronic device 500H, the distance between the second antenna 206H and the corresponding second grounding (GND) component in a closed configuration is less than the distance between the second antenna 206H and the corresponding second grounding (GND) components in an open configuration. Therefore, the second antenna 206H may have an increased signal-to-ground spacing in the open configuration in which the function of non-terrestrial network (NTN) communication and/or terrestrial network communication of the wearable electronic device 500H is activated, and the performance of the second antenna 206H of the wearable electronic device 500H can be improved.

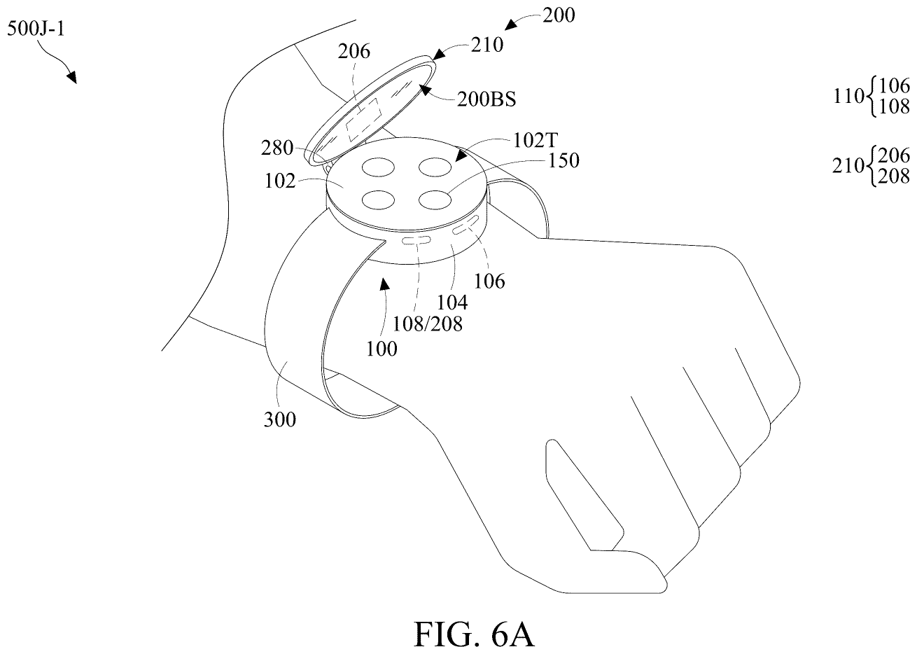

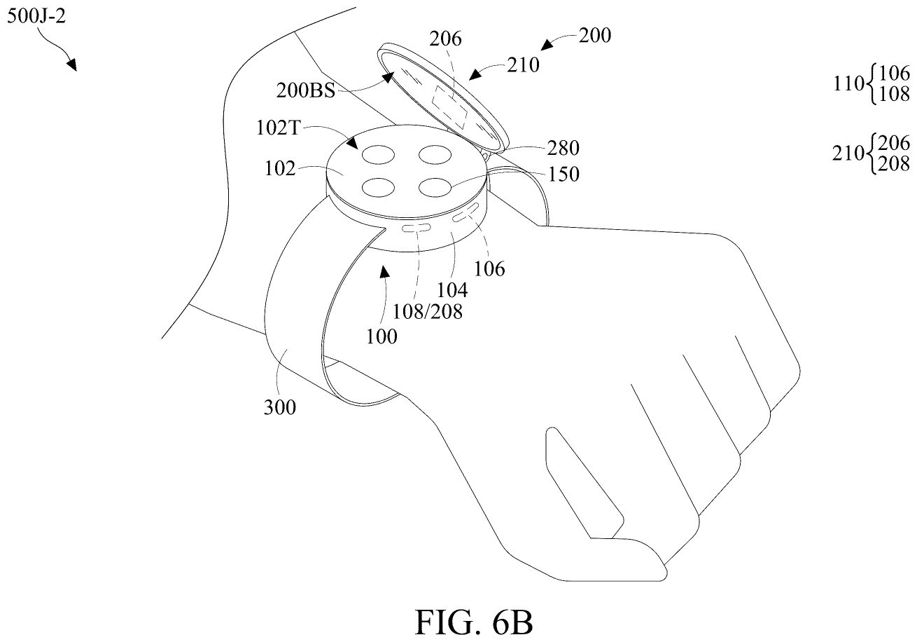

FIGS. 6A and 6B are schematic perspective views of wearable electronic devices 500J-1 and 500J-2 in an open configuration in accordance with some embodiments of the disclosure, showing the relative positions between a first structure 100 and a second structure 200 of each of the wearable electronic devices 500J-1 and 500J-2. Elements of the embodiments that are the same or similar to those previously described with reference to FIGS. 1A, 1B, 2, 3, 4A-4D, 5A and 5B are not repeated herein, in the interests of brevity.

As shown in FIGS. 6A and 6B, in some embodiments, each of the second structure 200 of the wearable electronic devices 500J-1 and 500J-2 may have functions of a cover or a secondary display. The second structure 200 is movably mounted on the first structure 100 by the hinge 280. The second structure 200 may be flipped away from the first structure 100 in the open configuration.

In some embodiments, the hinge 280 may be located between the 9 o'clock and 3 o'clock positions on the watch face 102T of the first structure 100 to facilitate the second structure 200 being flipped away from the first structure 100 by the user in the open configuration. For example, as shown in FIG. 6A, the hinge 280 of the wearable electronic device 500J-1 may be located at the 9 o'clock position on the watch face 102T of the first structure 100. As shown in FIG. 6B, the hinge 280 of the wearable electronic device 500J-2 may be located at the 1 o'clock position on the watch face 102T of the first structure 100.

In the wearable electronic devices 500J-1 and 500J-2, when the second structure 200 is flipped with respect to the first structure 100, the second antenna 206 of the second antenna module 210 of the second structure 200 may be arranged close to a bottom surface 200BS of the second structure 200 facing the first structure 100 in a closed configuration. Using this arrangement of the second antenna 206 of the wearable electronic devices 500J-1 and 500J-2, when the second structure 200 is flipped with respect to the first structure 100, the second antenna 206 of the second antenna module 210 of the second structure 200 may face inwardly in the closed configuration and face outwardly in the open configuration.

In some embodiments, the second grounding (GND) component 208 of the second antenna module 210 may be disposed in the first structure 100 and coupled to the second antenna 206. For example, the first grounding (GND) component 108 and the second grounding (GND) component 208 may be arranged in the same position in the first structure 100. The first grounding (GND) component 108 and the second grounding (GND) component 208 may be coupled to each other.

In some embodiments, since the second structures 200 of the wearable electronic devices 500J-1 and 500J-2 are provided as covers of the wearable electronic devices 500J-1 and 500J-2, the entire surface area of the second structures 200 of the wearable electronic devices 500J-1 and 500J-2 can be provided for the arrangement of the corresponding second antennas 206 of the wearable electronic devices 500J-1 and 500J-2 for non-terrestrial network (NTN) satellite communication and/or terrestrial network communication. Therefore, the second antenna 206 of each of the wearable electronic devices 500J-1 and 500J-2 may have an increased surface area and various designs of antenna types to improve communication efficiency (e.g., dual polarization or high gain).

In some embodiments, the function of non-terrestrial network (NTN) satellite communication and/or terrestrial network communication of the wearable electronic devices 500J-1 and 500J-2 may be activated only in the open configuration. Therefore, the standby time of the wearable electronic devices 500J-1 and 500J-2 may be further increased.

In the wearable electronic devices 500J-1 and 500J-2, the distance between the second antenna 206 and the second grounding (GND) component 208 in a closed configuration is less than the distance between the second antenna 206 and the grounding (GND) component 208 in an open configuration. Therefore, the second antenna 206 may have an increased signal-to-ground spacing in the open configuration in which the function of non-terrestrial network (NTN) communication and/or terrestrial network communication of the wearable electronic devices 500J-1 and 500J-2 is activated, and the performance of the second antenna 206 of the wearable electronic devices 500J-1 and 500J-2 can be improved.

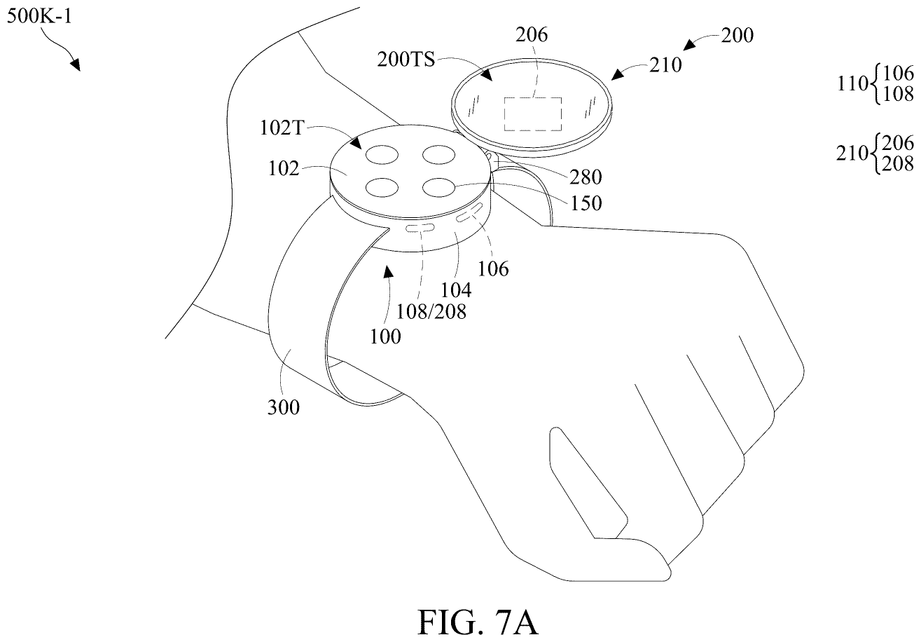

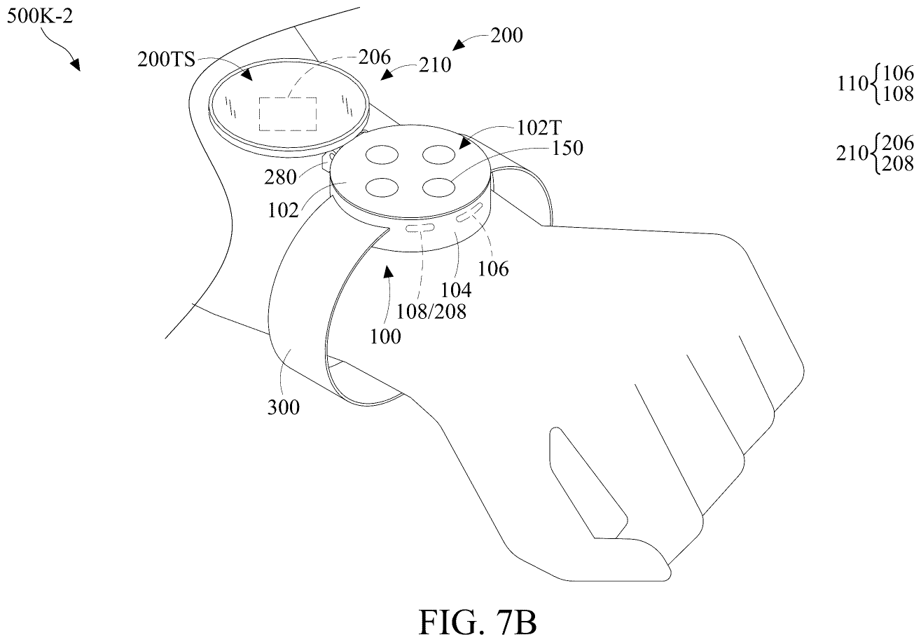

FIGS. 7A and 7B are schematic perspective views of wearable electronic devices 500K-1 and 500K-2 in an open configuration in accordance with some embodiments of the disclosure, showing the relative positions between a first structure 100 and a second structure 200 of each of the wearable electronic devices 500K-1 and 500K-2. Elements of the embodiments that are the same or similar to those previously described with reference to FIGS. 1A, 1B, 2, 3, 4A-4D, 5A, 5B, 6A and 6B are not repeated herein, in the interests of brevity.

In some embodiments as shown in FIGS. 7A and 7B, the second structure 200 of each of the wearable electronic devices 500K-1 and 500K-2 may have functions of a cover. The second structure 200 is mounted on the first structure 100 by the hinge 280. The second structure 200 may be rotated away from the first structure 100 in the open configuration.

In some embodiments, the hinge 280 may be located between the 9 o'clock and 3 o'clock positions on the watch face 102T of the first structure 100 to facilitate the second structure 200 being rotated away from the first structure 100 by the user in the open configuration. For example, as shown in FIG. 7A, the hinge 280 of the wearable electronic device 500K-1 may be located at the 12 o'clock position on the watch face 102T of the first structure 100. As shown in FIG. 7B, the hinge 280 of the wearable electronic device 500K-2 may be located at the 9 o'clock position on the watch face 102T of the first structure 100.

In the wearable electronic devices 500K-1 and 500K-2, when the second structure 200 is rotated with respect to the first structure 100, the second antenna 206 of the second antenna module 210 of the second structure 200 may be arranged close to a top surface 200T of the second structure 200 away from the first structure 100 in a closed configuration. Using this arrangement of the second antenna 206 of the wearable electronic devices 500K-1 and 500K-2, when the second structure 200 is rotated with respect to the first structure 100, the second antenna 206 of the second antenna module 210 of the second structure 200 may always face outwardly either in the close and open configurations.

In some embodiments, the second grounding (GND) component 208 of the second antenna module 210 may be disposed in the first structure 100 and coupled to the second antenna 206. For example, the first grounding (GND) component 108 and the second grounding (GND) component 208 may be arranged in the same position in the first structure 100. The first grounding (GND) component 108 and the second grounding (GND) component 208 may be coupled to each other.

In some embodiments, since the second structures 200 of the wearable electronic devices 500K-1 and 500K-2 are provided as covers of the wearable electronic devices 500K-1 and 500K-2, the entire surface area of the second structures 200 of the wearable electronic devices 500K-1 and 500K-2 can be provided for the arrangement of the corresponding second antennas 206 of the wearable electronic devices 500K-1 and 500K-2 for non-terrestrial network (NTN) satellite communication and/or terrestrial network communication. Therefore, the second antenna 206 of each of the wearable electronic devices 500K-1 and 500K-2 may have an increased surface area and various designs of antenna types to improve communication efficiency (e.g., dual polarization or high gain).

In some embodiments, the function of non-terrestrial network (NTN) satellite communication and/or terrestrial network communication of the wearable electronic devices 500K-1 and 500K-2 may be activated only in the open configuration. Therefore, the standby time of the wearable electronic devices 500K-1 and 500K-2 may be further increased.

In the wearable electronic devices 500K-1 and 500K-2, the distance between the second antenna 206 and the second grounding (GND) component 208 in a closed configuration is less than the distance between the second antenna 206 and the grounding (GND) component 208 in an open configuration. Therefore, the second antenna 206 may have an increased signal-to-ground spacing in the open configuration in which the function of non-terrestrial network (NTN) communication and/or terrestrial network communication of the wearable electronic devices 500K-1 and 500K-2 is activated, and the performance of the second antenna 206 of the wearable electronic devices 500K-1 and 500K-2 can be improved.

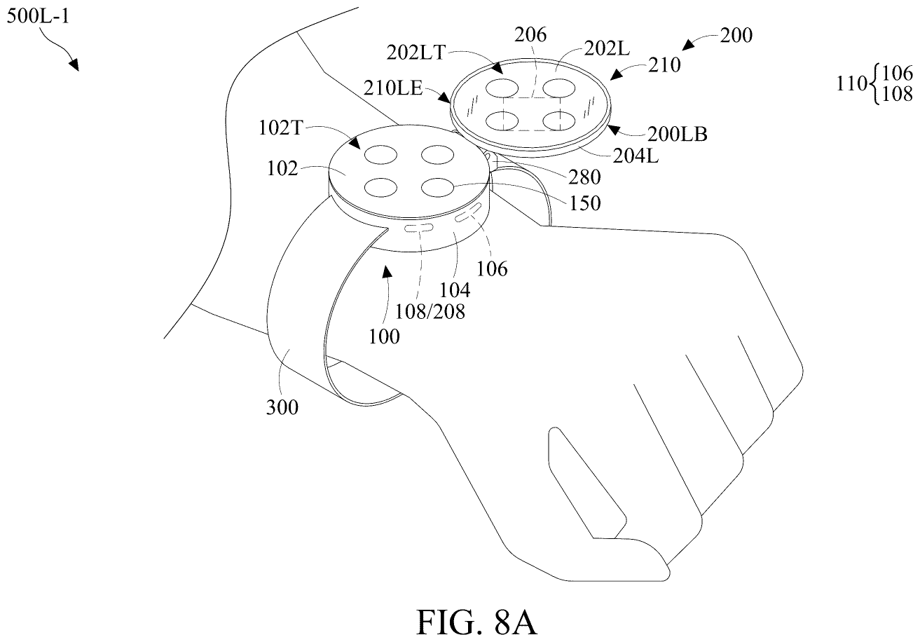

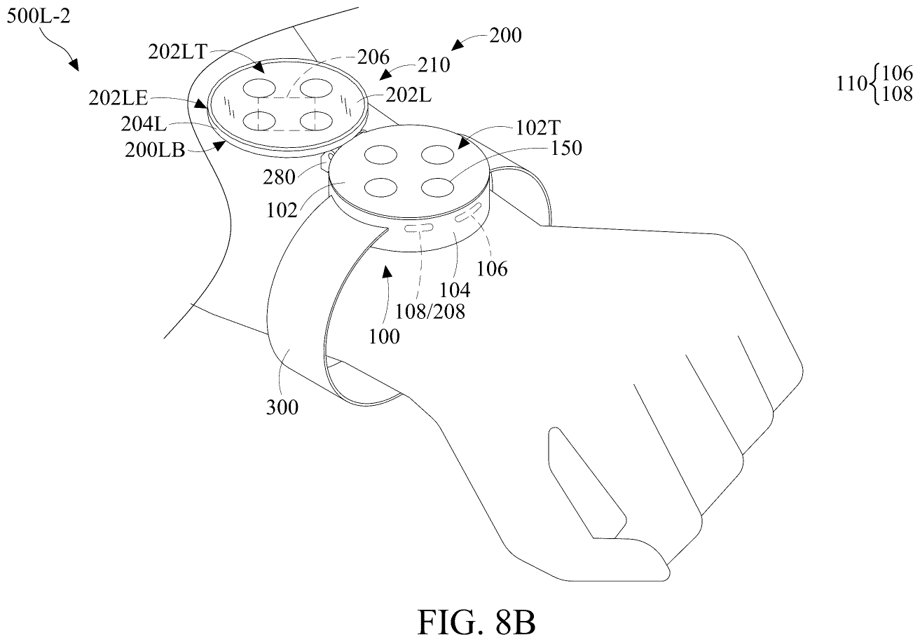

FIGS. 8A and 8B are schematic perspective views of wearable electronic devices 500L-1 and 500L-2 in an open configuration in accordance with some embodiments of the disclosure, showing the relative positions between A first structure 100 and A second structure 200 of each of the wearable electronic devices 500L-1 and 500L-2. Elements of the embodiments that are the same or similar to those previously described with reference to FIGS. 1A, 1B, 2, 3, 4A-4D, 5A, 5B, 6A, 6B, 7A and 7B are not repeated herein, in the interests of brevity.

In some embodiments as shown in FIGS. 8A and 8B, each of the second structure 200 of the wearable electronic devices 500L-1 and 500L-2 may have a function of a secondary display. The second structure 200L of each of the wearable electronic devices 500L-1 and 500L-2 may include a display module 202L and a housing 204L. The display module 202L may be coupled to the display module 102 of the first structure 100. In addition, the display module 202L, for example, a touch screen module, may receive inputs, such as touch inputs, from the user. In some embodiments, the display module 202L may be controlled by the first structure 100. In addition, the top surface 202LT of the display module 202L may serve as another watch face (or a secondary watch face) of each of the wearable electronic devices 500L-1 and 500L-2. In some embodiments as shown in FIGS. 8A and 8B, when the wearable electronic device 500L-1 (or 500L-2) is in the open configuration (i.e., when the first structure 100 is exposed from the second structure 200), the second structure 200 can serve as a secondary display. In this case, the wearable electronic device 500L-1 (or 500L-2) features two displays: the primary display is located on the top surface of the first structure 100, while the secondary display is on the bottom surface of the second structure 200 (the side facing the first structure 100 in the closed configuration).

The housing 204L may define a space for accommodating the display module 202L. As shown in FIGS. 8A and 8B, the display module 202L is disposed in the housing 204L. An outer surface of the housing 204L may be substantially defined as at least a portion of an outer surface of second structure 200.

As shown in FIGS. 8A and 8B, the second structure 200L is mounted on the first structure 100 by the hinge 280. The second structure 200L may be rotated away from the first structure 100 in the open configuration.

In some embodiments, the hinge 280 may be located between the 9 o'clock and 3 o'clock positions on the watch face 102T of the first structure 100 to facilitate the second structure 200L being rotated away from the first structure 100 by the user in the open configuration. For example, as shown in FIG. 8A, the hinge 280 of the wearable electronic device 500L-1 may be located at the 12 o'clock position on the watch face 102T of the first structure 100. As shown in FIG. 8B, the hinge 280 of the wearable electronic device 500L-2 may be located at the 9 o'clock position on the watch face 102T of the first structure 100.

In the wearable electronic devices 500L-1 and 500L-2, when the second structure 200L is rotated with respect to the first structure 100 and has a function of a secondary display, the second antenna 206L of the second antenna module 210L of the second structure 200L may be embedded in the second structure 200L. For example, the second antenna 206L of the second antenna module 210L may be disposed close to an edge 200LE of the second structure 200L or under the second display module 202L (or close to a bottom surface 200 LB of the second structure 200L). Using this arrangement of the second antenna 206L of the wearable electronic devices 500L-1 and 500L-2, when the second structure 200L is rotated with respect to the first structure 100, the second antenna 206L of the second antenna module 210L of the second structure 200L may face outwardly in the open configuration.

In some embodiments, the second grounding (GND) component 208 of the second antenna module 210L may be disposed in the first structure 100 and coupled to the second antenna 206. For example, the first grounding (GND) component 108 and the second grounding (GND) component 208 may be arranged in the same position in the first structure 100. The first grounding (GND) component 108 and the second grounding (GND) component 208 may be coupled to each other.

In some embodiments, since the display module 202L may be controlled by the first structure 100, the second structure 200 may have a larger space for the second antenna module 210 disposed on or in it. The second antenna 206L of the second antenna module 210L may be designed to have larger surface area than the first antenna 106 of the first structure 100, thereby improving non-terrestrial network (NTN) satellite communication and/or terrestrial network communication efficiency of the wearable electronic devices 500L-1 and 500L-2. Therefore, the second antenna 206 of each of the wearable electronic devices 500L-1 and 500L-2 may have an increased surface area and various designs of antenna types to improve communication efficiency (e.g., dual polarization or high gain).

In some embodiments, the function of non-terrestrial network (NTN) satellite communication and/or terrestrial network communication of the wearable electronic devices 500L-1 and 500L-2 may be activated only in the open configuration. Therefore, the standby time of the wearable electronic devices 500K-1 and 500K-2 may be further increased.

In the wearable electronic devices 500L-1 and 500L-2, the distance between the second antenna 20L6 and the second grounding (GND) component 208 in a closed configuration is less than the distance between the second antenna 206L and the grounding (GND) component 208 in an open configuration. Therefore, the second antenna 206L may have an increased signal-to-ground spacing in the open configuration in which the function of non-terrestrial network (NTN) communication and/or terrestrial network communication of the wearable electronic devices 500L-1 and 500L-2 is activated, and the performance of the second antenna 206L of the wearable electronic devices 500L-1 and 500L-2 can be improved.

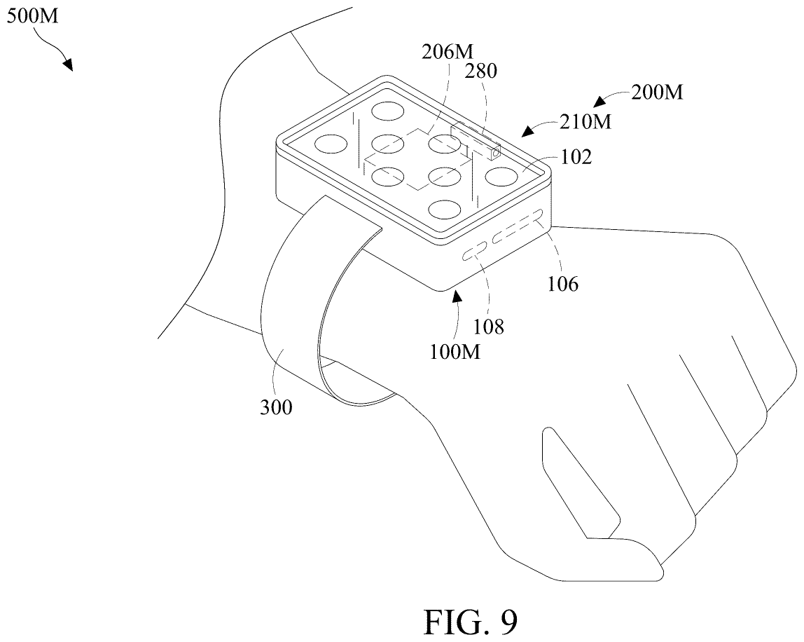

FIG. 9 is a schematic perspective view of a wearable electronic device 500M in a closed configuration in accordance with some embodiments of the disclosure. Elements of the embodiments that are the same or similar to those previously described with reference to FIGS. 1A, 1B, 2, 3, 4A-4D, 5A, 5B, 6A, 6B, 7A and 7B are not repeated herein, in the interests of brevity. As shown in FIGS. 1A and 9, the difference between the wearable electronic device 500A and the wearable electronic device 500M at least includes that the wearable electronic device 500M includes a first structure 100M and a second structure 200M movably mounted on the first structure 100M. In addition, the first structure 100M and the second structure 200M are both rectangular shape.

In some embodiments, the second structure 200M is mounted on the first structure 100M by a hinge 280. A second antenna 206M of the second structure 200M is mounted in or on the second structure 200H. The first structures 100 and 100M may have the same or similar function and include the same or similar components. The second structures 200A and 200M may have the same or similar function and include the same or similar components. In addition, the number, arrangements and type of the second antenna 206M may have the same or similar to those of any of the second antennas disclosed in the previous embodiments.

In some embodiments, the second structure 200M may be flipped, folded, slidable or rotated with respect to the first structure 100M. For example, as shown in FIG. 9, when the wearable electronic device 500M is in the closed configuration, the second structure 200M may completely or partially cover the first structure 100M.

In some embodiments, when the wearable electronic device 500M is in the open configuration, the second structure 200M may be flipped, unfolded, slid, or rotated with respect to the first structure 100M. In addition, the relative positions between the first structure 100M and the second structure 200M of the wearable electronic device 500M in the open configuration may be the same or similar to the relative positions between the first structure and the second structure of any of the wearable electronic devices 500A-500H, 500J-1, 500J-2, 500K-1, 500K-2, 500L-1 and 500L-2. The function of non-terrestrial network (NTN) satellite communication and/or terrestrial network communication of the wearable electronic device 500M provided by the second structure 200M may be activated only when the first structure 100M and the second structure 200M are in the open configuration.

In some embodiments, when the second structure 200M is provided as a cover of the wearable electronic device 500M, the entire surface area of the second structure 200M can be provided for the arrangements of corresponding second antenna 206M for non-terrestrial network (NTN) satellite communication and/or terrestrial network communication. Therefore, the second antenna 206M may have an increased surface area to improve non-terrestrial network (NTN) satellite communication and/or terrestrial network communication efficiency. Therefore, the second antenna 206M of the wearable electronic device 500M may have an increased surface area and various designs of antenna types to improve communication efficiency (e.g., dual polarization or high gain).

In some embodiments, the function of non-terrestrial network (NTN) satellite communication and/or terrestrial network communication of the wearable electronic device 500M may be activated only in the open configuration. Therefore, the standby time of the wearable electronic device 500M may be further increased.

Alternatively, when the second structure 200M is provided as a secondary display controlled by the first structure 100M, the second structure 200M may have a larger space for the second antenna module 210M disposed on or in it. The second antenna 206M of the second antenna module 210M may be designed to have larger surface area than the first antenna 106 of the first structure 100M, thereby improving non-terrestrial network (NTN) satellite communication and/or terrestrial network communication efficiency of the wearable electronic device 500M.

In some embodiments, when the second grounding (GND) component (not shown) of the second antenna module 210M is arranged in the first structure 100 of the wearable electronic device 500M (e.g., the second grounding (GND) component may be arranged in the same position within the first structure 100 as the first grounding (GND) component 108 of the first structure 100M), the distance between the second antenna 206M and the corresponding second grounding (GND) component in a closed configuration is less than the distance between the second antenna 206M and the corresponding second grounding (GND) component in an open configuration. Therefore, the second antenna 206M may have increased signal-to-ground spacing in the open configuration in which the function of non-terrestrial network (NTN) communication and/or terrestrial network communication of the wearable electronic device 500M is activated, and the performance of the second antenna 206M of the wearable electronic device 500M can be improved.

Embodiments provide a wearable electronic device. The wearable electronic device includes a first structure and a second structure. The first structure includes a first antenna module embedded in the first structure. The second structure is movably mounted on the first structure. The second structure includes a second antenna module disposed in or on the second structure.

In some embodiments, the first antenna module and the second antenna module are used for terrestrial network communication and/or non-terrestrial network (NTN) satellite communication.

In some embodiments, the first structure further includes a housing and a display module disposed on the housing.

In some embodiments, the first structure further comprises a watch dial, and the second structure further comprises a cover or a display module movably mounted on the watch dial, and wherein the first antenna module is disposed in/on the watch dial and the second antenna module is disposed in/on the cover or the display module.

In some embodiments, the first antenna module includes a first antenna, the second antenna module includes a second antenna, and each of the first and second antennas includes a dipole antenna, a loop antenna, a single patch antenna or a circular polarization antenna or an antenna array thereof.

In some embodiments, the first structure has a circular shape, a rectangular shape, or an oval shape.

In some embodiments, the second structure is flipped, folded, slidable or rotated with respect to the first structure.

In some embodiments, a function of non-terrestrial network (NTN) satellite communication and/or terrestrial network communication of the wearable electronic device may be activated only when the first structure and the second structure are in an open configuration in which the second structure is flipped, unfolded, slid, or rotated away from the first structure.

In some embodiments, the second structure is slidable or rotated with respect to the first structure and covered by the first structure in an open configuration.

In some embodiments, when the second structure is flipped with respect to the first structure, the second antenna module of the second structure is arranged close to a surface of the second structure facing the first structure in a closed configuration.

In some embodiments, the second antenna is arranged along an edge of the second structure.

In some embodiments, the second antenna module further includes a second grounding (GND) component.

In some embodiments, a first distance between the second antenna and the second grounding (GND) component in a closed configuration is less than a second distance between the second antenna and the grounding (GND) component in an open configuration.

In some embodiments, the second antenna and the second grounding (GND) component are arranged opposite each other and along a first portion and a second portion of an edge of the second structure.

In some embodiments, the second structure is mounted on the first structure by a hinge.

In some embodiments, the second structure has a circular shape, a rectangular shape, or an oval shape corresponding to a shape of the first structure.

In some embodiments, the wearable electronic device further includes a lens mounted on the second structure and covering the second antenna module.

In some embodiments, the wearable electronic device further includes at least one wristband connected to the first structure.

In some embodiments, the second antenna module is made of transparent material or opaque material.

In some embodiments, the second structure is made of transparent material or opaque material.

The wearable electronic device has the following advantages.

In some embodiments, when the second structure of the wearable electronic device is provided as a cover of the wearable electronic device, the entire surface area of the second structure can be provided for the arrangements of corresponding second antenna for non-terrestrial network (NTN) satellite communication and/or terrestrial network communication. Therefore, the second antenna may have an increased surface area to improve non-terrestrial network (NTN) satellite communication and/or terrestrial network communication efficiency. Therefore, the second antenna of each of the wearable electronic device 500M may have an increased surface area and various designs of antenna types to improve communication efficiency (e.g., dual polarization or high gain).

In addition, the function of non-terrestrial network (NTN) satellite communication and/or terrestrial network communication of the wearable electronic device provided by the second antenna may be activated only in the open configuration. Therefore, the standby time of the wearable electronic device may be further increased.

In some embodiments, when the second structure is provided as a secondary display controlled by the first structure, the second structure may have a larger space for the second antenna module disposed on or in it. The second antenna of the second antenna module may be designed to have larger surface area than the first antenna (for terrestrial network communication and/or non-terrestrial network (NTN) satellite communication) of the first structure 100M, thereby improving non-terrestrial network (NTN) satellite communication and/or terrestrial network communication efficiency of the wearable electronic device.

In some embodiments, when the second grounding (GND) component (not shown) of the second antenna module is arranged in the first structure of the wearable electronic device (e.g., the first and second grounding (GND) components may be arranged in the same position in the first structure), the distance between the second antenna and the corresponding second grounding (GND) component in a closed configuration is less than the distance between the second antenna and the corresponding second grounding (GND) component in an open configuration. Therefore, the second antenna may have increased signal-to-ground spacing in the open configuration in which the function of non-terrestrial network (NTN) communication and/or terrestrial network communication of the wearable electronic device is activated, and the performance of the second antenna of the wearable electronic device can be improved.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A wearable electronic device, comprising:
a first structure comprising a first antenna module embedded in the first structure; and
a second structure movably mounted on the first structure, wherein the second structure comprises a second antenna module disposed in or on the second structure.

2. The wearable electronic device as claimed in claim 1, wherein the first structure further comprises a housing and a display module disposed on the housing.

3. The wearable electronic device as claimed in claim 1, wherein the first structure further comprises a watch dial, and the second structure further comprises a cover or a display module movably mounted on the watch dial, and wherein the first antenna module is disposed in/on the watch dial and the second antenna module is disposed in/on the cover or the display module.

4. The wearable electronic device as claimed in claim 1, wherein the first antenna module comprises a first antenna, the second antenna module comprises a second antenna, and each of the first and second antennas comprises a dipole antenna, a loop antenna, a single patch antenna or a circular polarization antenna or an antenna array thereof.

5. The wearable electronic device as claimed in claim 1, wherein the second structure is flipped, folded, slidable or rotated with respect to the first structure.

6. The wearable electronic device as claimed in claim 5, wherein the second structure is slidable or rotated with respect to the first structure and covered by the first structure in an open configuration.

7. The wearable electronic device as claimed in claim 5, wherein when the second structure is flipped with respect to the first structure, the second antenna module of the second structure is arranged close to a surface of the second structure facing the first structure in a closed configuration.

8. The wearable electronic device as claimed in claim 4, wherein the second antenna is arranged along an edge of the second structure.

9. The wearable electronic device as claimed in claim 5, wherein the second antenna module further comprises a second grounding (GND) component.

10. The wearable electronic device as claimed in claim 9, wherein a first distance between the second antenna and the second grounding (GND) component in a closed configuration is less than a second distance between the second antenna and the grounding (GND) component in an open configuration.

11. The wearable electronic device as claimed in claim 9, wherein the second antenna and the second grounding (GND) component are arranged opposite each other and along a first portion and a second portion of an edge of the second structure.

12. The wearable electronic device as claimed in claim 1, wherein the second structure is mounted on the first structure by a hinge.

13. The wearable electronic device as claimed in claim 1, wherein the second structure has a circular shape, a rectangular shape, or an oval shape corresponding to a shape of the first structure.

14. The wearable electronic device as claimed in claim 1, further comprising:
a lens mounted on or in the second structure and covering the second antenna module.

15. The wearable electronic device as claimed in claim 1, further comprising:
at least one wristband connected to the first structure.

16. The wearable electronic device as claimed in claim 1, wherein the second antenna module is made of a transparent material or an opaque material.

17. The wearable electronic device as claimed in claim 1, wherein the second structure is made of a transparent material or an opaque material.
